(19) United States
(12) Patent Application Publication
(10) Pub. No.: US 2026/0063919 A1
(43) Pub. Date: Mar. 5, 2026

(54) RAPID INTEGRATED PRECISION RETICLE

(71) Applicant: DRAGONSLAYER SYSTEMS LLC, Lawton, OK (US)

(72) Inventor: Nicholas A. Culbert, Lawton, OK (US)

(73) Assignee: DRAGONSLAYER SYSTEMS LLC, Lawton, OK (US)

(21) Appl. No.: 19/310,577

(22) Filed: Aug. 26, 2025

Related U.S. Application Data
(60) Provisional application No. 63/687,440, filed on Aug. 27, 2024.

(51) Int. Cl. G02B 27/34; F41G 1/473

(52) U.S. Cl. CPC G02B 27/34; F41G 1/473

(57) ABSTRACT

Apparatus and associated methods relate to a reticle configured to use in a firearm optic. In an illustrative example, reticle may include a central hollow polygon located at a center of a sighting field. The central hollow polygon may, for example, include a plurality of connected linear segments forming a geometric shape. The reticle may, for example, include at least one horizontal line extending laterally outward from the central hollow polygon. The reticle may, for example, include at least one vertical line extending vertically from the central hollow polygon. The reticle may, for example, include at least one aiming point positioned within or adjacent to the central hollow polygon. Various embodiments may advantageously deliver rapid, intuitive target acquisition and engagement without reliance on digital systems, enabling shooters to respond effectively to fast-moving threats with minimal delay or complexity.

### CROSS-REFERENCE TO RELATED APPLICATIONS

This application is a nonprovisional application and claims the benefit of U.S. Application Ser. No. 63/687,440, titled “Rapid Integrated Precision Reticle” filed by Nicholas A. Culbert on Aug. 27, 2024.

This application incorporates the entire contents of the foregoing application(s) herein by reference.

### TECHNICAL FIELD

Various embodiments relate generally to precision firing systems and firearms.

### BACKGROUND

Firearms and optical reticles are integral components in precision shooting. Firearms, ranging from handguns to rifles, may, for example, be designed for some purposes, from self-defense to hunting and sport shooting. Optical reticles, the aiming guides within scopes or sights, enhance accuracy by providing a visual point of reference. These reticles come in various designs, such as crosshairs, dots, or BDC (Bullet Drop Compensator) patterns, each tailored for specific shooting scenarios. The combination of a well-matched firearm and an appropriate optical reticle allows shooters to engage targets with greater precision and confidence.

### SUMMARY

Apparatus and associated methods relate to a reticle configured to use in a firearm optic. In an illustrative example, reticle may include a central hollow polygon located at a center of a sighting field. The central hollow polygon may, for example, include a plurality of connected linear segments forming a closed geometric shape. The reticle may, for example, include at least one horizontal line extending laterally outward from the central hollow polygon. The reticle may, for example, include at least one vertical line extending vertically from the central hollow polygon. The reticle may, for example, include at least one aiming point positioned within or adjacent to the central hollow polygon. Various embodiments may advantageously deliver rapid, intuitive target acquisition and engagement without reliance on digital systems, enabling shooters to respond effectively to fast-moving threats with minimal delay or complexity.

Various embodiments may achieve one or more advantages. The rapid integrated precision (RIP) reticle may, for example, be advantageously include the central shape assist range configured for engaging moving aerial targets and small unmanned aerial systems (s-UAS). The RIP reticle may, for example, advantageously engage moving aerial targets, particularly small unmanned aerial systems (s-UAS) as categorized by the Department of Defense UAS Groups 1-3. The RIP reticle may, for example, be designed as a non-adaptive, constant feature that significantly improves shooting accuracy by enabling effective target leading. The RIP reticle may, for example, be compatible with magnifiers, configured such that the reticle enhances precision at greater distances. The RIP reticle may, for example, be adapted for various optic types suited to long-range and mission-specific applications.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary rapid integrate precision reticle system (RIPRS) employed in an illustrative use-case scenario.

FIG. 2 depicts an exemplary embodiment of a RIPRS within an exemplary embodiment of a reticle cell.

FIG. 3 depicts another exemplary embodiment of a reticle cell.

FIG. 4 depicts an exemplary embodiment of a RIPRS with an annular segmented peripheral reference ring.

FIG. 5 depicts an exemplary embodiment of a RIPRS with an exemplary embodiment of at least one horizontal indicator and at least one vertical indicator.

FIG. 6 depicts an exemplary second embodiment of at least one horizontal indicator and at least one vertical indicator.

FIG. 7 depicts an exemplary embodiment of a RIPRS with at least one aiming point.

FIG. 8 depicts an exemplary third embodiment of at least one horizontal indicator and at least one vertical indicator.

FIG. 9 depicts an exemplary fourth embodiment of at least one horizontal indicator and at least one vertical indicator.

FIG. 10 depicts an exemplary embodiment of a RIPRS with an at least one oblique line.

FIG. 11 depicts another embodiment of an at least one oblique line.

FIG. 12 depicts an exemplary fifth embodiment of at least one horizontal indicator.

FIG. 13 depicts exemplary embodiments of a central hollow polygon.

FIG. 14 is a flowchart illustrating an exemplary method of operation of a RIPRS.

FIG. 15 is a flowchart illustrating an exemplary method of operation of a RIPRS during a training simulation.

Like reference symbols in the various drawings indicate like elements.

### DETAILED DESCRIPTION OF ILLUSTRATIVE EMBODIMENTS

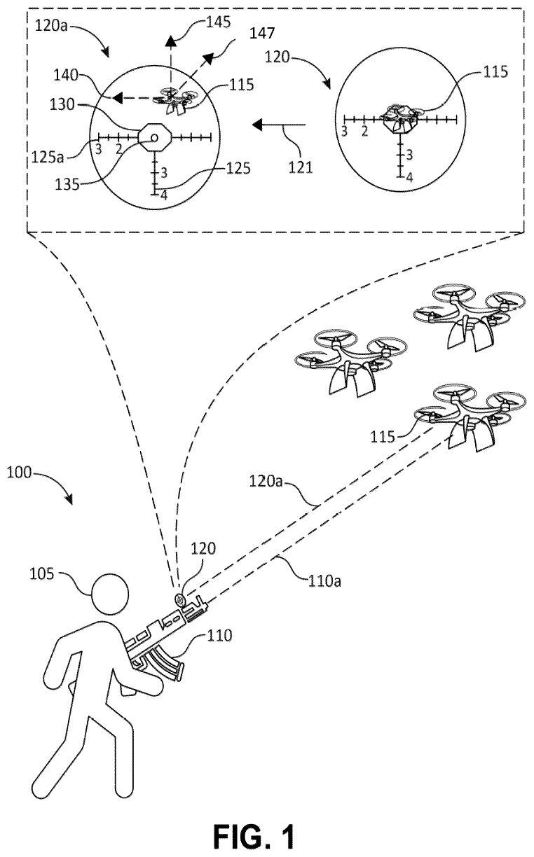

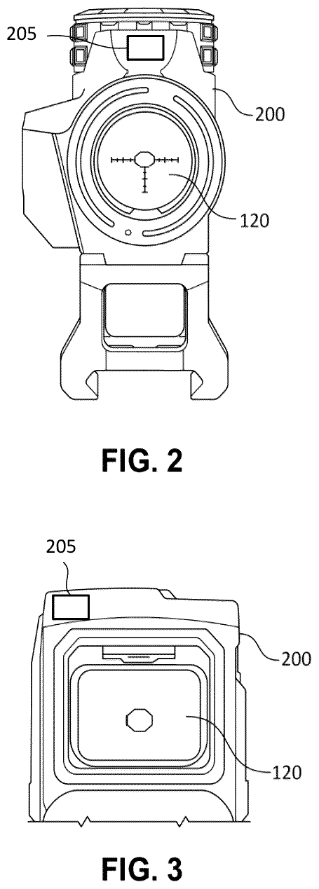

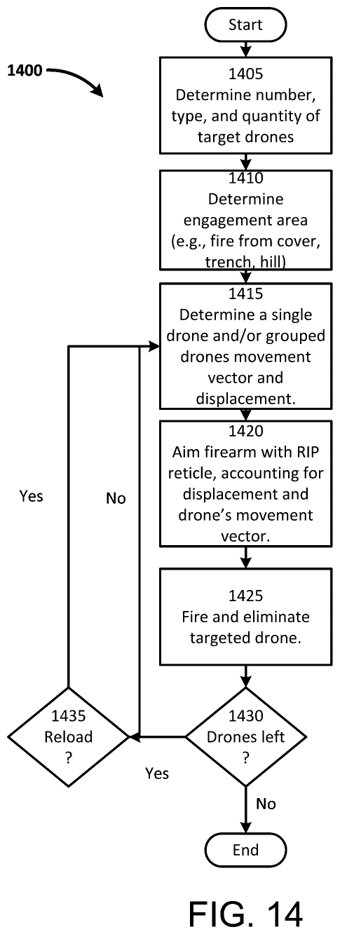

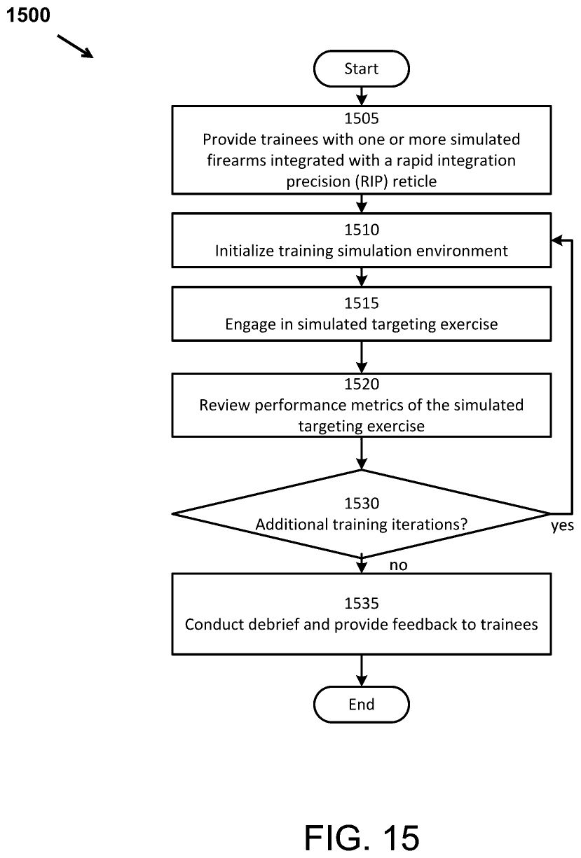

To aid understanding, this document is organized as follows. First, to help introduce discussion of various embodiments, a rapid integrate precision reticle system (RIPRS) is introduced with reference to FIGS. 1-13. Second, that introduction leads into a description with reference to FIGS. 2-13 of some exemplary embodiments of features of an RIPRS. Third, with reference to FIGS. 14-15, a RIPRS is described in exemplary application methods. Finally, the document discusses further embodiments, exemplary applications and aspects relating to RIPRS.

FIG. 1 depicts an exemplary rapid integrate precision reticle system (RIPRS) 100 employed in an illustrative use-case scenario. The illustrative use-scenario depicted in FIG. 1 includes a user 105. The user 105 may, for example, be a soldier. The user 105 is firing a firearm 110. The firearm 110 may, for example, include an assault rifle. The firearm 110 may, for example, include a rifle. The firearm 110 may, for example, include a pistol. The firearm 110 may, for example, include a machine gun. The firearm 110 may, for example, include a submachine gun. The firearm 110 may, for example, include a shotgun.

The firearm 110 includes a line of fire 110a. Projectiles may, for example, travel along the line of fire 110a extending from the muzzle of the firearm 110. The line of fire 110a may, for example, extend to a target 115. The target 115 may, for example, include a drone. The target 115 may, for example, include a small unmanned aerial system (s-UAS). The user 105 may, for example, be combatting multiple targets 115.

The firearm 110 may, for example, operatively couple a rapid integrate precision (RIP) reticle 120. The RIP reticle 120 may, for example, include at least one vertical indicator 125. The RIP reticle 120 may, for example, include at least one horizontal indicator 125a. The at least one vertical indicator 125 and at least one horizontal indicator 125a may, for example, advantageously enable the user 105 to adjust their aim in the horizontal and/or vertical direction depending on the dynamic vectors of the target and/or external conditions.

The RIP reticle 120 may, for example, lock onto the target 115 by extending a central hollow polygon 130 over the target 115. The central hollow polygon 130 may, for example, include an at least one aiming point 135 positioned within the central hollow polygon 130.

The user 105 may, for example, transition 121 their aim into a different aim configuration 120a based on the targets'115 dynamic vectors in the x, y, z direction (e.g., vector may, for example, include displacement, velocity, and drone acceleration in the x, y, z directions). In the illustrative use-case scenario depicted in FIG. 1, the target 115 may, for example, move in the dynamic vector x-direction 140. The target 115 may, for example, move in the dynamic vector y-direction 145. The target 115 may, for example, move in the dynamic vector z-direction 147. The user 105 may, for example, use their initial targeting for the initial displacement of the target 115, and then adjust their aim due to the target's dynamic movements. The user may, for example, adjust the aim based on external forces, such as gravity, wind, curvature of the earth, and/or weather (e.g., fog, rain, hail, etc.).

FIG. 2 depicts an exemplary embodiment of the RIPRS 100 within an exemplary embodiment of a reticle cell 200. The RIPRS 100 includes the RIP reticle 120. The RIP reticle 120 may, for example, be housed within the reticle cell 200. The RIPRS 100 may, for example, include a power source 205. FIG. 3 depicts another exemplary embodiment of the reticle cell 200. The power source 205 may, for example, power the RIP reticle 120. For example, the RIP reticle 120 may, for example, include an optical light source configured to illuminate the RIP reticle 120. The RIP reticle may, for example, include a first operational mode in which the RIP reticle 120 functions without the power source 205. The RIP reticle 120 may, for example, include a second operational mode in which the RIP reticle 120 is powered by the power source 205. The RIP reticle 120 may, for example, be configured to switch between the first and second modes to enable functionality in both a non-illuminated condition and an illuminated condition.

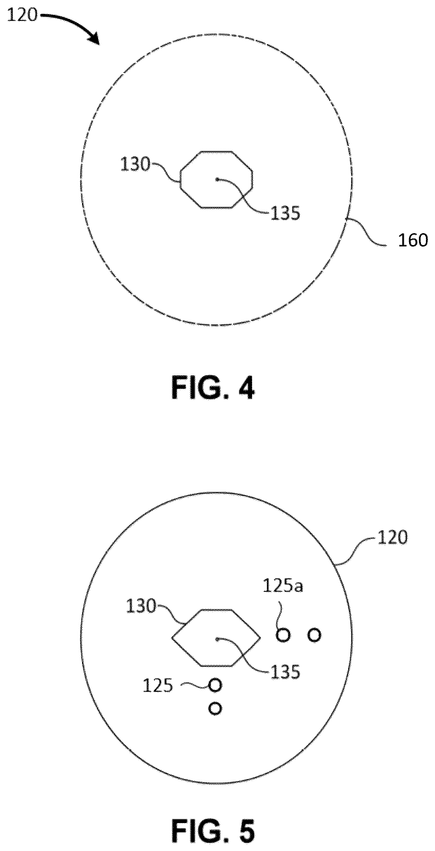

FIG. 4 depicts an exemplary embodiment of a RIPRS 100 with an annular segmented peripheral reference ring 160. The RIPRS 100 include the RIP reticle 120. The RIP reticle 120 may, for example, include the annular segmented peripheral reference ring 160. The annular segmented peripheral reference ring 160 may, for example, be configured to provide a peripheral visual aid designed to represent the approximate spread pattern of projectiles. The annular segmented peripheral reference ring 160 may, for example, advantageously be useful in shotgun applications. The annular segmented peripheral reference ring 160 may, for example, include a dashed or segmented circular ring surrounding the central hollow polygon 130. The annular segmented peripheral reference ring 160 may, for example, advantageously provide a shooter with a rapid visual reference for the maximum dispersion area at a predetermined range, allowing for quicker target acquisition and alignment when precision is less critical or when engaging fast-moving aerial threats. By visually encoding the expected spread, the annular segmented peripheral reference ring 160 may, for example, advantageously enhance situational awareness and support intuitive engagement, particularly in scenarios where time-to-fire is limited or the target is erratic.

FIG. 5 depicts an exemplary embodiment of a RIPRS 100 with an exemplary embodiment of at least one horizontal indicator 125a and at least one vertical indicator 125. The at least one horizontal indicator 125a and at least one vertical indicator 125 may, for example, advantageously assist shooters in accurately engaging moving aerial and ground targets. The at least one horizontal indicator 125a and at least one vertical indicator 125 may, for example, include linear lines. The at least one horizontal indicator 125a and at least one vertical indicator 125 may, for example, include dots. The at least one horizontal indicator 125a and at least one vertical indicator 125 may, for example, include tick marks. The at least one horizontal indicator 125a and at least one vertical indicator 125 may, for example, include other geometric markers. The at least one horizontal indicator 125a and at least one vertical indicator 125 may, for example, extend outward from the central hollow polygon 130 along horizontal and vertical axes. The at least one horizontal indicator 125a and at least one vertical indicator 125 may, for example, advantageously provide reference points to estimate lead and elevation adjustments based on a target's speed, direction, and distance.

The at least one horizontal indicator 125a and at least one vertical indicator 125 may, for example, may be spaced either evenly or unevenly and can be positioned at fixed angular intervals (e.g., 45°, 71°, 181°) to support predictive tracking across linear, curved, oblique, spiral, or compound motion paths. The at least one horizontal indicator 125a and at least one vertical indicator 125 may, for example, be etched. The at least one horizontal indicator 125a and at least one vertical indicator 125 may, for example, be projected. The at least one horizontal indicator 125a and at least one vertical indicator 125 may, for example, be holographically displayed. The at least one horizontal indicator 125a and at least one vertical indicator 125 may, for example, help shooters estimate angular velocity, trajectory deflection, and pitch, enabling rapid and intuitive adjustments during dynamic engagements. The at least one horizontal indicator 125a and at least one vertical indicator 125 may, for example, be compatible across analog, digital, and hybrid optical platforms.

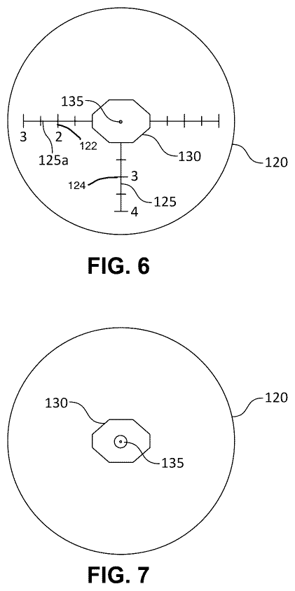

FIG. 6 depicts an exemplary second embodiment of at least one horizontal indicator and at least one vertical indicator. The at least one horizontal indicator 125a may, for example, be positioned laterally adjacent to the central hollow polygon 130. The at least one horizontal indicator 125a may, for example, include a predetermined position relative to the central hollow polygon 130. The at least one horizontal indicator 125a may, for example be configured to provide visual references of lateral displacement of an aerial target. The at least one horizontal indicator 125a may, for example, include one or more numerical indicators 122. The numerical indicators 122 may, for example, be calibrated to correspond to target speeds of a typical s-UAS. The numerical indicators 122 may, for example, calibrated to correspond to target speeds ranging from 20 to 60 meters per second.

The at least one vertical indicator 125 may, for example, be positioned vertically adjacent to the central hollow polygon 130. The at least one vertical indicator 125 may, for example, include a predetermined position relative to the central hollow polygon 130. The at least one vertical indicator 125 may, for example, be configured to provide visual references of elevation alignment and vertical offset to an aerial target. The at least one vertical indicator 125 may, for example, include one or more numerical indicators 124. The numerical indicators 124 may, for example, be calibrated to correspond to one or more engagement distances of a typical s-UAS. The numerical indicators 124 may, for example, calibrated to correspond to one or more engagement distance between 0 to 600 meters.

FIG. 7 depicts an exemplary embodiment of a RIPRS 100 with at least one aiming point 135. The at least one aiming point 135 may, for example, include a central visual marker positioned at the geometric center of the central hollow polygon 130. The at least one aiming point 135 may, for example, advantageously serve as a primary reference for precision targeting and be designed to support both point-target engagements (e.g., a single drone or object) and area-target estimations (e.g., swarms or moving formations) depending on the operational context.

Functionally, the at least one aiming point 135 may, for example, advantageously enable a shooter to quickly align their weapon with the target's projected path. The at least one aiming point 135 may, for example, be configured to be adjusted based on the target's velocity, trajectory, and angular displacement.

The at least one aiming point 135 may, for example, be etched. The at least one aiming point 135 may, for example, be illuminated. The at least one aiming point 135 may, for example, be projected. The at least one aiming point 135 may, for example, be digitally rendered. The at least one aiming point 135 may, for example, advantageously remain consistent across analog, hybrid, and digital optical platforms.

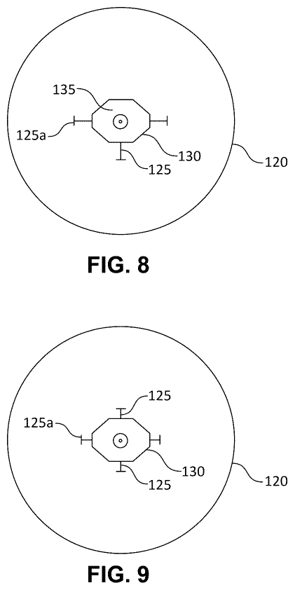

FIG. 8 depicts an exemplary third embodiment of at least one horizontal indicator 125a and at least one vertical indicator 125. FIG. 9 depicts an exemplary fourth embodiment of at least one horizontal indicator and at least one vertical indicator. The at least one horizontal indicator 125a depicted in FIGS. 8-9 include a T-shaped reference marker. The at least one vertical indicator 125 depicted in FIGS. 8-9 include a T-shaped reference marker.

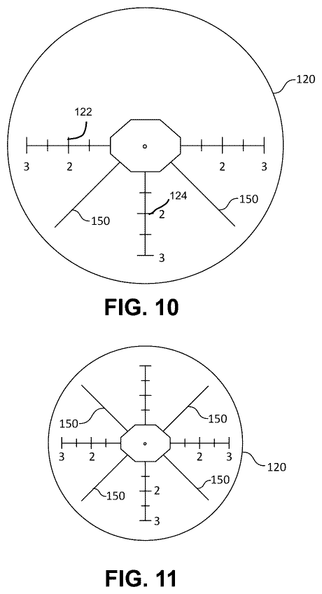

FIG. 10 depicts an exemplary embodiment of a RIPRS 100 with an at least one oblique line 150. FIG. 11 depicts another embodiment of an at least one oblique line 150. The at least one oblique line 150 may, for example, be configured to provide a motion reference indicator designed to enhance targeting accuracy of aerial threats exhibiting non-linear or angular movement. The at least one oblique line 150 may, for example, be positioned at diagonal angles relative to at least one aiming point 135. The at least one oblique line 150 may, for example, span multiple orientations within a 360-degree field.

The at least one oblique line 150 may, for example, extend radially from the central hollow polygon 130. The at least one oblique line 150 may, for example, include a predetermined position relative to the central hollow polygon 130. The at least one oblique line 150 may, for example, be configured to provide one or more visual references of a direction of movement and a projectile lead compensation of the aerial target.

The at least one oblique line 150 may, for example, advantageously assist in estimating lead for targets moving along angled trajectories, which is useful for erratic or high-agility flight patterns. The at least one oblique line 150 may, for example, advantageously provide visual cues for adjusting aim based on angular velocity, pitch, and trajectory deflection. The at least one oblique line 150 may, for example, advantageously support predictive tracking by visually encoding motion vectors that deviate from standard lateral or vertical paths.

The at least one oblique line 150 may, for example, be constructed using solid lines. The at least one oblique line 150 may, for example, be constructed using dashed formats The at least one oblique line 150 may, for example, be spaced evenly. The at least one oblique line 150 may, for example, be spaced unevenly. The at least one oblique line 150 may, for example, advantageously enable shooters to bracket and engage targets that do not follow predictable horizontal or vertical movement, such as drones executing evasive maneuvers or spiraling flight paths.

The at least one oblique line 150 may, for example, be etched. The at least one oblique line 150 may, for example, be projected. The at least one oblique line 150 may, for example, be holographically displayed. The at least one oblique line 150 may, for example, be digitally rendered.

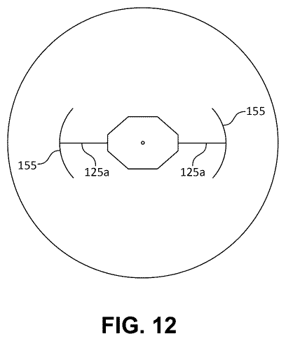

FIG. 12 depicts an exemplary fifth embodiment of at least one horizontal indicator 125a. The at least one horizontal indicator depicted in FIG. 12 includes a linear line with a curved potion 155.

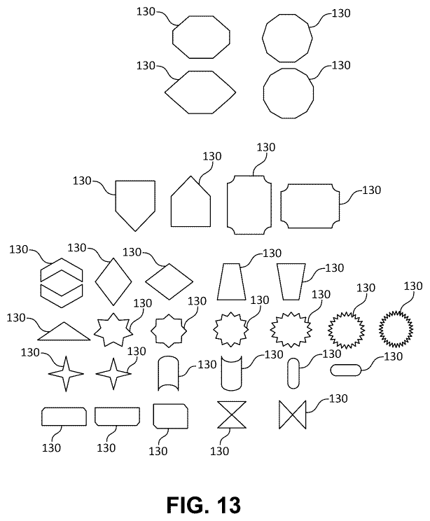

FIG. 13 depicts exemplary embodiments of a central hollow polygon 130. The central hollow polygon 130 may, for example, be located at a center of a sighting field. The central hollow polygon 130 may, for example, be defined by at least two connected linear segments forming a closed geometric shape. The central hollow polygon 130 may, for example, be dimensioned to visually correspond to a cross-sectional silhouette of an aerial target at a predetermined range. The central hollow polygon 130 may, for example, include a plurality of connected linear segments forming a closed geometric shape. The central hollow polygon 130 may, for example, include a shape that visually corresponds to a silhouette of a s-UAS.

FIG. 14 is a flowchart illustrating an exemplary method 1400 of operation of a RIPRS 100. In step 1405, the user assesses the environment to determine the number, type, and quantity of target drones. In step 1410 the user of the method determines the engagement area, considering geographical features like cover from trees, trenches, and/or hills that may affect visibility and strategy. In step, 1415 the user may, for example, calculate the movement vectors and displacement of either a single drone and/or a group of drones.

In step 1420, the user aims their firearm using the RIP reticle, adjusting for the drones'movements and positions. In step 1425, once aimed the user fires at the drone to neutralize it. In step 1430, after firing, the user checks if there are any drones remaining. In step 1435, if drones are still present and engagement continues, the user may need to reload the firearm. After step 1435, the method 1400 reverts to step 1415. If no drones are left to engage, the method 1400 ends. This method 1400 may, for example, be used for the precise and effective engagement of drones in a combat and/or defense scenario using the advanced targeting capabilities of the RIP reticle 120.

FIG. 15 is a flowchart illustrating an exemplary method 1500 of operation of a RIPRS 100 during a training simulation. In a step 1505, trainees are provided with one or more simulated firearms integrated with the RIP reticle 120. For example, firearms may be matched with trainees according to trainee roles (e.g., rifle, shotgun, crew-served). A user may, for example, ensure the RIP reticles 120 are properly aligned and calibrated.

In a step 1510, a user initializes a training simulation environment. For example, step 1510 may include loading drone engagement scenario on engagement skills trainer or virtual reality base systems. Step 1510 may, for example, include configuring terrain, weather, and lighting conditions of the training simulation.

In a step 1515, a user engages in the simulated targeting exercise. For example, the user practices engaging virtual drones using the RIP reticle 120. The simulated targeting exercise may, for example, include single or swarm drone threats. The targets may, for example, move dynamically in 3D space. The user may, for example, apply the RIP reticle 120 to track, lead, and engage target. The simulated targeting exercise may, for example, include timed drills, accuracy scoring, and adaptive difficulty.

In a step 1520, a user reviews performance metrics of the simulated targeting exercise. The performance metrics may, for example, include hit accuracy and engagement time. The performance metrics may, for example include reticle usage effectiveness (e.g., proper lead estimation). The performance metrics may, for example include decision-making under simulated combat stress.

In a step 1530, the user reaches a decision point where the user decides based on the performance metrics if additional training iteration should be done. If yes, the method 1500 reverts to step 1510. If no, the method 1500 proceeds to step 1535.

In a step 1535, the user conducts a debrief and provides feedback to the trainees. For example, the user may discuss the effectiveness of the tactical decisions made during the simulation exercise. The user may, for example, address common errors, encourage feedback and answer questions from trainees.

Although various embodiments have been described with reference to the figures, other embodiments are possible.

In some implementations, the RIP reticle 120 may also be referred to as the multi-domain reticle system (MDRS). In some embodiments, the features of the RIP reticle 120 (e.g., numerical indicators 122, numerical indicators 124, at least one vertical indicator 125, at least one horizontal indicator 125a, central hollow polygon 130, at least one aiming point 135, at least one oblique line 150, and annular segmented peripheral reference ring 160) may be represented in a variety of color formats. For example, the features of the RIP reticle 120 may, include a red color format. For example, the features of the RIP reticle 120 may, include a green color format. For example, the features of the RIP reticle 120 may, include a black color format. For example, the features of the RIP reticle 120 may, include a blue color format.

In some embodiments, the RIP reticle 120 may, for example, be employed in various domains of warfare. For example, the RIP reticle 120 may, for example, be employed in land warfare. For example, the RIP reticle 120 may be employed in air warfare. For example, the RIP reticle 120 may be employed in space warfare. For example, the RIP reticle 120 may be employed in maritime warfare. For example, the RIP reticle 120 may be employed in surface and below surface warfare. In some embodiments, the RIP reticle 120 may, for example, be compatible with advanced targeting software that facilitates automated tracking and engagement, making it suitable for integration into complex weapon systems on combat drones or remotely operated turrets. The RIP reticle 120 may, for example, support various rendering methods, including display on digital screens, heads-up displays, and other high-tech optical interfaces, ensuring versatile deployment in field conditions.

In some embodiments, the RIP reticle 120 may, for example, be designed to adapt to multiple mounting configurations, including shoulder-fired and vehicle-mounted setups, allowing for flexible application in dynamic combat environments.

In some embodiments, the RIP reticle 120 may, for example, be engineered to function optimally across different environments and light conditions, incorporating adjustable settings to enhance visibility and accuracy on digital displays or through enhanced optics solutions.

In some embodiments, the method of targeting drones with a RIP reticle 120 may, for example, involve manually adjusting the reticle to accommodate for different sizes and speeds of drones. A user may, for example, select from a range of reticle shapes, such as hexagonal or circular, each specifically designed for different drone profiles. During targeting, the user may, for example, utilize a sliding scale on the reticle to estimate the drone's distance, adjusting the aiming point accordingly. For moving targets, the RIP reticle 120 may, for example, include dynamic markings that provide real-time feedback on the drone's velocity and direction changes. In scenarios involving high-density drone swarms, the reticle may, for example, allow the user to lock onto multiple targets simultaneously, streamlining the engagement process. The RIP reticle 120 may, for example, feature color-coded sectors to indicate priority targets, helping the user to effectively manage multiple threats.

In some embodiments, the RIP reticle 120 may, for example, be used by active military personnel. The RIP reticle 120 may, for example, integrate with various firearm systems, offering a robust solution for both dynamic and stationary targets. In some embodiments, the RIP reticle 120 may, for example, be developed with input that emphasizes user-friendly features to accommodate operators without advanced technical training. The RIP reticle 120 may, for example, include intuitive interfaces and clear visual indicators that simplify target acquisition and tracking, making it accessible for users at all skill levels. In some embodiments, the RIP reticle 120 may, for example, incorporate user implemented methods that optimize targeting under varied conditions and movements.

In some embodiments, the method for determining the cross-section of the shape for targeting different types of drones with the RIP reticle 120 may, for example, involve analyzing the geometric profiles of commonly encountered drone models to pre-configure a variety of reticle shapes. The reticle shapes may, for example, be designed to mimic the aerial footprint of specific drones, such as hexagonal for multi-rotor drones or elongated for fixed-wing models. This configuration may, for example, allow for rapid switching between reticle shapes as the engagement scenario evolves and different types of drones enter the operational area.

In some embodiments, the RIP reticle 120 includes a hollow, hexagonal shape circle at its center. The hexagonal nature of this feature may, for example, advantageously enable rapid target acquisition in the manner traditionally achieved by hollow sight reticles but amplified for counter small unmanned aerial systems (cs-UAS) use by modifying the RIP reticle 120 to mimic the geometrical features of common s-UAS platforms. Furthermore, the RIP reticle 120 may include an additional center dot/aiming point(s) inside the hollow circle for more refined point shooting of a fixed, stationary, or moving target (e.g., s-UAS platform).

In some embodiments, the RIP reticle 120 may include a series of evenly spaced horizontal lines extending outward (left and right) from the hollow circle with a small, solid or hollow center dot. These lines represent different lead distances to help the shooter aim ahead of a moving target at different speeds. Each line is marked with a corresponding distance indicator, calibrated for typical aerial target speeds and various distances (e.g., 0-500 meters).

In some embodiments, the RIP reticle 120 includes vertical reference lines to aid in maintaining/adjusting for elevation alignment while tracking the target. The RIP reticle 120 may, for example, advantageously aid and enhance a shooter's ability to engage moving, semi-stationary, or stationary s-UAS effectively without extensive external training requirements or additional, expensive, and cumbersome equipment.

In some embodiments, the RIP reticle 120 may, for example, integrate with targeting software that controls various weapon systems, including automated turrets and grenade launchers. This RIP reticle 120 may, for example, display targeting information directly on a gunner's interface, optimizing engagement accuracy from fixed or mobile platforms. The RIP reticle 120 may be fitted to enhance functionality when mounted on high-caliber weaponry, such as .50 caliber machine guns on strategic high points, enabling defenders to maintain a broader and more effective field of control. The RIP reticle 120 may, for example, advantageously interface effectively with various optical systems, ensuring that operators can switch between weapon systems without losing targeting efficiency.

The RIP reticle 120 reticle may, for example, serve as a versatile optical tool capable of fulfilling the role of traditional red dot and/or holographic sights. The RIP reticle 120 may, for example, advantageously transition seamlessly between specialized aerial targeting and more conventional ground-based engagements. Training may, for example, incorporate elements of traditional marksmanship while emphasizing the dynamic targeting capabilities required for engaging fast-moving aerial targets. The training program could include modules on understanding the hexagonal reticle's lead distance markers, adjusting for elevation, and transitioning between aerial and ground targets, ensuring that military personnel can maximize the reticle's potential in diverse combat situations.

In some embodiments, the RIP reticle 120 may, for example, advantageously enable the engagement moving aerial targets, specifically s-UAS. The RIP reticle 120 may, for example, include evenly spaced horizontal lines extending from a hexagonal shaped holo-sight reticle further defined with an interior smaller dot or aiming points, each marked with distance indicators calibrated for typical aerial target speeds and distance. The RIP reticle 120 may, for example, includes vertical reference lines for maintaining elevation alignment.

In some embodiments, both the horizontal and vertical lines extending from the RIP reticle's 120 center feature numeric designators. The numeric designators may, for example, advantageously increase targeting aids to the shooter. The RIP reticle 120 may, for example, be paired with optics housings that are constructed from durable, lightweight, shock-resistant, and waterproof materials, and which accommodate adjustable illumination, windage, and elevation mechanisms.

In some embodiments, the paired housing may, for example, include an integrated mounting system compatible with picatinny and/or weaver rails with optional quick-detach mechanisms. The RIP reticle 120 may, for example, be compatible with magnifiers to enhance user accuracy at greater distances and transferable to different optic styles (red dot, low power variable optics, telescopic sights, etc.).

In some embodiments, the RIP reticle 120 may, for example, be used in combat. The RIP reticle 120 may, for example, be used in connection to military personnel exposed to enemy s-UAS platforms. The RIP reticle 120 may, for example, be used to organically and/or effectively engage enemy s-UAS at combat engagement distances. The RIP reticle 120 may, for example, be used as an important tool for modern militaries to effectively respond to hostile drones.

In some embodiments, the RIP reticle 120 may, for example, be used in optical sighting systems. The RIP reticle 120 may, for example, be integrated into weapon-mounted optics, and reticles designed to assist shooters in engaging moving aerial targets. The RIP reticle 120 may, for example, advantageously be employed in engaging s-UAS at typical engagement distances of military personnel. For example, typical engagement distances of military personnel may include distances roughly between 0-600 meters. In some embodiments, the RIP reticle 120 may facilitate dual-use capabilities for the engagement of traditional, ground-based targets.

In some embodiments, the RIP reticle 120 may, for example, be transferable to different reticle construction types, including but not limited to, glass-etched, fiber, and wire reticles for maximum scalability and use of the reticle for different weapon systems and their traditionally favored sighting system.

In some embodiments, the RIP reticle 120 may, for example, be compatible with fixed and/or variable zoom optic magnifiers, allowing the shooter to enhance accuracy at greater distances. Magnifiers may, for example, be attached and/or detached, providing flexibility for different shooting scenarios.

In some embodiments, the RIP reticle 120 may, for example, include support for and with windage and elevation adjustment systems to enable a user to zero the RIP reticle 120 to themselves, their specific firearm and ammunition.

In some embodiments, the RIP reticle 120 may, for example, be illuminated using a high-efficiency LED light source, providing a clear and bright aiming point under different lighting conditions. The illumination intensity may, for example, be adjustable, allowing the shooter to customize the brightness based on the ambient lighting conditions. The illumination may, for example, be compatible with night vision and thermal devices. The RIP reticle's 120 integration with an illumination source may, for example, advantageously minimize the user's electromagnetic footprint in their operating environment thereby increasing user safety.

In some embodiments, the RIP reticle 120 may advantageously address the limitations of red dot/reflex sight optic. The RIP reticle 120 may, for example, advantageously overcome the challenges posed by fast-moving aerial targets, such as s-UAS, which can be difficult to predict in terms of path and speed. Furthermore, the RIP reticle 120 may, advantageously address the limitations of modern military rifles and their associated cartridges, which are typically designed for point target engagement. The RIP reticle may, for example, advantageously enhance shooter accuracy and provide targeting aids in such scenarios.

Although an exemplary system has been described with reference to FIGS. 1-15, other implementations may be deployed in other industrial, scientific, medical, commercial, and/or residential applications.

In industrial applications, the RIP reticle 120 may, for example, be employed in environments where precision targeting is important for operations involving UAS. For instance, in large-scale construction or mining sites, the RIP reticle 120 may assist operators in monitoring and engaging drones that are used for surveying and/or mapping. By integrating the RIP reticle 120 into security protocols, industrial facilities may enhance their ability to counter unauthorized drone incursions, thereby protecting sensitive areas from potential threats or interference.

In scientific research, the RIP reticle 120 may, for example, be utilized in experiments that require precise tracking and engagement of fast-moving aerial targets. For example, in environmental monitoring, researchers may use drones equipped with the RIP reticle 120 to accurately follow and target specific wildlife species or environmental elements, such as tracking migratory patterns or collecting atmospheric data. The RIP reticle 120 may, for example, be used in aerospace testing. The RIP reticle 120 may, for example, be used to assist scientists in engaging and tracking experimental drones or other aerial vehicles under controlled conditions.

In the commercial sector, the RIP reticle 120 may, for example, be used to ensure the accurate delivery of packages by drones, especially in areas with complex terrain or obstacles. In agriculture, the RIP reticle 120 may help operators engage with drones that are used for crop monitoring or pest control, allowing for precise interventions that improve yield and efficiency. Security firms may also deploy the RIP reticle 120 in commercial buildings to enhance drone detection and engagement capabilities, safeguarding critical infrastructure.

In residential settings, the RIP reticle 120 may be used by homeowners to protect their property from potential aerial intrusions, such as unauthorized drones. For example, in rural or suburban areas, residents may deploy the RIP reticle 120 in conjunction with personal defense systems to engage drones that could pose a threat to privacy or security. The RIP reticle 120 may, for example, be used in recreational activities, such as drone racing and/or target shooting, where it may provide enthusiasts with a tool to improve their precision and accuracy in engaging fast-moving targets and/or observing fast moving targets, making it a valuable addition to outdoor sports or hobbyist pursuits.

In some embodiments, the RIP reticle 120 may, for example, include intensity settings adjustable to accommodate different ambient light conditions and designed for compatibility with optics housings minimizing an electromagnetic footprint.

In some embodiments, the RIP reticle 120 may, for example, include integration capabilities for windage and elevation adjustments for its supported optic housing allowing for the reticle to be zeroed to the individual shooter and/or weapons system.

In some aspects, the techniques described herein relate to a reticle system including: one or more firearms; and, a reticle apparatus including: a central hollow polygon located at a center of a sighting field, the polygon defined by at least two connected linear segments forming a geometric shape, wherein the central hollow polygon is dimensioned to visually correspond to a cross-sectional silhouette of an aerial target at a predetermined range; at least one horizontal indicator positioned laterally adjacent of the central hollow polygon, wherein the at least one horizontal indicator includes a predetermined position relative to the central hollow polygon configured to provide visual references of lateral displacement of the aerial target; at least one vertical indicator positioned vertically adjacent of the central hollow polygon, wherein the at least one vertical indicator includes a predetermined position relative to the central hollow polygon configured to provide visual references of elevation alignment and vertical offset to the aerial target; and, at least one aiming point positioned within the central hollow polygon, wherein the at least one aiming point includes a predetermined position relative to the central hollow polygon configured to provide selectable aiming references of an adjusting projectile trajectory based on an estimated movement vector of the aerial target.

In some aspects, the techniques described herein relate to a reticle system, wherein the at least one horizontal indicator and the at least one vertical indicator further include linear lines.

In some aspects, the techniques described herein relate to a reticle system, further including at least one oblique line extending radially from the central hollow polygon, wherein the at least one oblique line includes a predetermined position relative to the central hollow polygon configured to provide one or more visual references of a direction of movement and a projectile lead compensation of the aerial target.

In some aspects, the techniques described herein relate to a reticle system, wherein the central hollow polygon further includes a plurality of connected linear segments forming a closed geometric shape.

In some aspects, the techniques described herein relate to a reticle system, wherein the at least one horizontal indicator and the at least one vertical indicator further include substantially circular dots.

In some aspects, the techniques described herein relate to a reticle system, wherein the central hollow polygon further includes a shape that visually corresponds to a silhouette of a small unmanned aerial system.

In some aspects, the techniques described herein relate to a reticle system, wherein the at least one horizontal indicator further includes one or more numerical indicators calibrated to correspond to target speeds of a typical small unmanned aerial system

In some aspects, the techniques described herein relate to a reticle system, wherein the at least one vertical indicator further includes numerical indicators calibrated to correspond to one or more engagement distances of a typical small unmanned aerial system.

In some aspects, the techniques described herein relate to a reticle system, wherein the reticle apparatus further includes an annular segmented peripheral reference ring surrounding the central hollow polygon and visually representing an approximate projectile spread area at a predetermined range.

In some aspects, the techniques described herein relate to a reticle system, further including a power source, wherein the reticle apparatus further includes a first operational mode in which the reticle apparatus functions without a power source, and a second operational mode in which the reticle apparatus is powered by a power source, wherein the reticle apparatus is configured to switch between the first and second modes to enable functionality in both a non-illuminated condition and an illuminated condition.

In some aspects, the techniques described herein relate to a reticle apparatus including: a central hollow polygon located at a center of a sighting field, the polygon defined by at least two connected linear segments forming a geometric shape, wherein the central hollow polygon is dimensioned to visually correspond to a cross-sectional silhouette of an aerial target at a predetermined range; at least one horizontal indicator positioned laterally adjacent of the central hollow polygon, wherein the at least one horizontal indicator includes a predetermined position relative to the central hollow polygon configured to provide visual references of lateral displacement of the aerial target; at least one vertical indicator positioned vertically adjacent of the central hollow polygon, wherein the at least one vertical indicator includes a predetermined position relative to the central hollow polygon configured to provide visual references of elevation alignment and vertical offset to the aerial target; and, at least one aiming point positioned within the central hollow polygon, wherein the at least one aiming point includes a predetermined position relative to the central hollow polygon configured to provide selectable aiming references of an adjusting projectile trajectory based on an estimated movement vector of the aerial target.

In some aspects, the techniques described herein relate to a reticle apparatus, further including at least one oblique line extending radially from the central hollow polygon, wherein the at least one oblique line includes a predetermined position relative to the central hollow polygon configured to provide one or more visual references of a direction of movement and a projectile lead compensation of the aerial target.

In some aspects, the techniques described herein relate to a reticle apparatus, wherein the central hollow polygon further includes a plurality of connected linear segments forming a closed geometric shape.

In some aspects, the techniques described herein relate to a reticle apparatus, wherein the at least one horizontal indicator and the at least one vertical indicator further include substantially circular dots.

In some aspects, the techniques described herein relate to a reticle apparatus, wherein the central hollow polygon further includes a shape that visually corresponds to a silhouette of a small unmanned aerial system.

In some aspects, the techniques described herein relate to a reticle apparatus, wherein the at least one horizontal indicator further includes one or more numerical indicators calibrated to correspond to target speeds of a typical small unmanned aerial system.

In some aspects, the techniques described herein relate to a reticle apparatus, wherein the at least one vertical indicator further includes numerical indicators calibrated to correspond to one or more engagement distances of a typical small unmanned aerial system.

In some aspects, the techniques described herein relate to a reticle apparatus, further including an annular segmented peripheral reference ring surrounding the central hollow polygon and visually representing an approximate projectile spread area at a predetermined range.

In some aspects, the techniques described herein relate to a reticle apparatus, further including a power source, wherein the reticle apparatus further includes a first operational mode in which the reticle apparatus functions without a power source, and a second operational mode in which the reticle apparatus is powered by a power source, wherein the reticle apparatus is configured to switch between the first and second modes to enable functionality in both a non-illuminated condition and an illuminated condition.

In some aspects, the techniques described herein relate to a method of engaging an aerial target including: providing one or more simulated firearms integrated with a reticle apparatus, the reticle apparatus including: a central hollow polygon located at a center of a sighting field, the polygon defined by at least two connected linear segments forming a geometric shape, wherein the central hollow polygon is dimensioned to visually correspond to a cross-sectional silhouette of an aerial target at a predetermined range; at least one horizontal indicator positioned laterally adjacent of the central hollow polygon, wherein the at least one horizontal indicator includes a predetermined position relative to the central hollow polygon configured to provide visual references of lateral displacement of the aerial target; at least one vertical indicator positioned vertically adjacent of the central hollow polygon, wherein the at least one vertical indicator includes a predetermined position relative to the central hollow polygon configured to provide visual references of elevation alignment and vertical offset to the aerial target; and, at least one aiming point positioned within the central hollow polygon, wherein the at least one aiming point includes a predetermined position relative to the central hollow polygon configured to provide selectable aiming references of an adjusting projectile trajectory based on an estimated movement vector of the aerial target; initializing a simulated training exercise configured to replicate aerial target engagement scenarios; presenting simulated aerial targets with dynamic movement vectors, the dynamic movement vectors including: displacement, velocity, and directional changes; assessing an operational environment to identify a position of the simulated aerial targets; determining an engagement area of the simulated aerial target; calculating the movement vectors of the simulated aerial target; aligning the central hollow polygon over the aerial target; selecting an aiming position within the central hollow polygon based on the calculated movement vectors of the simulated aerial target; adjusting the aiming position using the at least one horizontal indicator and the at least one vertical indicator; firing a projectile toward the aerial target based on the adjusted aiming position; recording reticle apparatus utilization metrics, the metrics including engagement accuracy and response time in hitting the simulated aerial targets; and, repeating the simulated training exercise.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A reticle system comprising:
one or more firearms; and,
a reticle apparatus comprising:
a central hollow polygon located at a center of a sighting field, the polygon defined by at least two connected linear segments forming a geometric shape, wherein the central hollow polygon is dimensioned to visually correspond to a cross-sectional silhouette of an aerial target at a predetermined range;
at least one horizontal indicator positioned laterally adjacent of the central hollow polygon, wherein the at least one horizontal indicator comprises a predetermined position relative to the central hollow polygon configured to provide visual references of lateral displacement of the aerial target;
at least one vertical indicator positioned vertically adjacent of the central hollow polygon, wherein the at least one vertical indicator comprises a predetermined position relative to the central hollow polygon configured to provide visual references of elevation alignment and vertical offset to the aerial target; and,
at least one aiming point positioned within the central hollow polygon, wherein the at least one aiming point comprises a predetermined position relative to the central hollow polygon configured to provide selectable aiming references of an adjusting projectile trajectory based on an estimated movement vector of the aerial target.

2. The reticle system of claim 1, wherein the at least one horizontal indicator and the at least one vertical indicator further comprise linear lines.

3. The reticle system of claim 1, further comprising at least one oblique line extending radially from the central hollow polygon, wherein the at least one oblique line comprises a predetermined position relative to the central hollow polygon configured to provide one or more visual references of a direction of movement and a projectile lead compensation of the aerial target.

4. The reticle system of claim 1, wherein the central hollow polygon further comprises a plurality of connected linear segments forming a closed geometric shape.

5. The reticle system of claim 1, wherein the at least one horizontal indicator and the at least one vertical indicator further comprise substantially circular dots.

6. The reticle system of claim 1, wherein the central hollow polygon further comprises a shape that visually corresponds to a silhouette of a small unmanned aerial system.

7. The reticle system of claim 1, wherein the at least one horizontal indicator further comprises one or more numerical indicators calibrated to correspond to target speeds of a typical small unmanned aerial system

8. The reticle system of claim 1, wherein the at least one vertical indicator further comprises numerical indicators calibrated to correspond to one or more engagement distances of a typical small unmanned aerial system.

9. The reticle system of claim 1, wherein the reticle apparatus further comprises an annular segmented peripheral reference ring surrounding the central hollow polygon and visually representing an approximate projectile spread area at a predetermined range.

10. The reticle system of claim 1, further comprising a power source, wherein the reticle apparatus further comprises a first operational mode in which the reticle apparatus functions without a power source, and a second operational mode in which the reticle apparatus is powered by a power source, wherein the reticle apparatus is configured to switch between the first and second modes to enable functionality in both a non-illuminated condition and an illuminated condition.

11. A reticle apparatus comprising:
a central hollow polygon located at a center of a sighting field, the polygon defined by at least two connected linear segments forming a geometric shape, wherein the central hollow polygon is dimensioned to visually correspond to a cross-sectional silhouette of an aerial target at a predetermined range;
at least one horizontal indicator positioned laterally adjacent of the central hollow polygon, wherein the at least one horizontal indicator comprises a predetermined position relative to the central hollow polygon configured to provide visual references of lateral displacement of the aerial target;
at least one vertical indicator positioned vertically adjacent of the central hollow polygon, wherein the at least one vertical indicator comprises a predetermined position relative to the central hollow polygon configured to provide visual references of elevation alignment and vertical offset to the aerial target; and,
at least one aiming point positioned within the central hollow polygon, wherein the at least one aiming point comprises a predetermined position relative to the central hollow polygon configured to provide selectable aiming references of an adjusting projectile trajectory based on an estimated movement vector of the aerial target.

12. The reticle apparatus of claim 11, further comprising at least one oblique line extending radially from the central hollow polygon, wherein the at least one oblique line comprises a predetermined position relative to the central hollow polygon configured to provide one or more visual references of a direction of movement and a projectile lead compensation of the aerial target.

13. The reticle apparatus of claim 11, wherein the central hollow polygon further comprises a plurality of connected linear segments forming a closed geometric shape.

14. The reticle apparatus of claim 11, wherein the at least one horizontal indicator and the at least one vertical indicator further comprise substantially circular dots.

15. The reticle apparatus of claim 11, wherein the central hollow polygon further comprises a shape that visually corresponds to a silhouette of a small unmanned aerial system.

16. The reticle apparatus of claim 11, wherein the at least one horizontal indicator further comprises one or more numerical indicators calibrated to correspond to target speeds of a typical small unmanned aerial system.

17. The reticle apparatus of claim 11, wherein the at least one vertical indicator further comprises numerical indicators calibrated to correspond to one or more engagement distances of a typical small unmanned aerial system.

18. The reticle apparatus of claim 11, further comprising an annular segmented peripheral reference ring surrounding the central hollow polygon and visually representing an approximate projectile spread area at a predetermined range.

19. The reticle apparatus of claim 11, further comprising a power source, wherein the reticle apparatus further comprises a first operational mode in which the reticle apparatus functions without a power source, and a second operational mode in which the reticle apparatus is powered by a power source, wherein the reticle apparatus is configured to switch between the first and second modes to enable functionality in both a non-illuminated condition and an illuminated condition.

20. A method of engaging an aerial target comprising:
providing one or more simulated firearms integrated with a reticle apparatus, the reticle apparatus comprising:
a central hollow polygon located at a center of a sighting field, the polygon defined by at least two connected linear segments forming a geometric shape, wherein the central hollow polygon is dimensioned to visually correspond to a cross-sectional silhouette of an aerial target at a predetermined range;
at least one horizontal indicator positioned laterally adjacent of the central hollow polygon, wherein the at least one horizontal indicator comprises a predetermined position relative to the central hollow polygon configured to provide visual references of lateral displacement of the aerial target;
at least one vertical indicator positioned vertically adjacent of the central hollow polygon, wherein the at least one vertical indicator comprises a predetermined position relative to the central hollow polygon configured to provide visual references of elevation alignment and vertical offset to the aerial target; and,
at least one aiming point positioned within the central hollow polygon, wherein the at least one aiming point comprises a predetermined position relative to the central hollow polygon configured to provide selectable aiming references of an adjusting projectile trajectory based on an estimated movement vector of the aerial target;
initializing a simulated training exercise configured to replicate aerial target engagement scenarios;
presenting simulated aerial targets with dynamic movement vectors, the dynamic movement vectors comprising: displacement, velocity, and directional changes;
assessing an operational environment to identify a position of the simulated aerial targets;
determining an engagement area of the simulated aerial target;
calculating the movement vectors of the simulated aerial target;
aligning the central hollow polygon over the aerial target;
selecting an aiming position within the central hollow polygon based on the calculated movement vectors of the simulated aerial target;
adjusting the aiming position using the at least one horizontal indicator and the at least one vertical indicator;
firing a projectile toward the aerial target based on the adjusted aiming position;
recording reticle apparatus utilization metrics, the metrics comprising engagement accuracy and response time in hitting the simulated aerial targets; and,
repeating the simulated training exercise.
